(19) United States
(12) Patent Application Publication
(10) Pub. No.: US 2008/0295723 A1
(43) Pub. Date: Dec. 4, 2008

(54) Printing press

(75) Inventor: Federico Kuhn, St. Gallen (CH)

Correspondence Address: LERNER GREENBERG STEMER LLP, P O BOX 2480, HOLLYWOOD, FL, 33022-2480, US

(73) Assignee: Heidelberger Druckmaschinen AG, Heidelberg (DE)

(21) Appl. No.: 12/133,058

(22) Filed: Jun. 4, 2008

(30) Foreign Application Priority Data
Jun. 4, 2007 (DE) 10 2007 026 027.1

(51) Int. Cl. B41L 15/14

(52) U.S. Cl. 101/480

(57) ABSTRACT

A printing press for processing a web of printing material, in particular for producing labels or packaging, includes a plurality of printing units which are convertible between different printing processes. Each of the convertible printing units includes at least one receiving element to releasably connect and receive a printing unit subassembly or printing unit component in such a way that the printing process can be implemented on the web of printing material passing through the printing unit in a printing nip formed between a cylinder and an impression cylinder. In order to provide diagonal register adjustment, the axis of rotation of the cylinder is tiltable relative to the axis of rotation of the impression cylinder by a linear movement of the at least one receiving element perpendicular to a direction of engagement between the cylinder and the impression cylinder.

### CROSS-REFERENCE TO RELATED APPLICATION

This application claims the priority, under 35 U.S.C. § 119, of German Patent Application DE 10 2007 026 027.1, filed Jun. 4, 2007; the prior application is herewith incorporated by reference in its entirety.

### BACKGROUND OF THE INVENTION

1. Field of the Invention

The invention relates to a printing press for processing a web of printing material, in particular for producing labels or packaging, including a plurality of printing units which can be converted between different printing processes and each of which includes at least one receiving element for releasably connecting and receiving a printing unit subassembly or a printing unit component in such a way that the printing process can be implemented on the web of printing material passing through the printing press in a nip formed by a cylinder and an impression cylinder.

In order to print labels or packaging, it is common practice to use printing presses that rely on a plurality of different printing processes to be able to exploit the special advantages of the individual printing processes in combination. For that purpose, there are printing presses with printing units, which can be easily converted from a first printing process to a second, different printing process by exchanging only one or a few printing unit subassemblies or printing unit components. Thus, the structure of the printing press can be adapted to produce a wide variety of printed products.

Such a generic convertible printing press is a machine known as Gallus RCS, manufactured and sold by Gallus Ferd. Rüesch AG, St. Gallen, Switzerland. Different models of that common type of printing press are identified by the addition of numbers. For example, a press known as RCS 330 is available. That generic convertible printing press processes a web of printing material in a plurality of processing stations, in particular printing units, which are disposed in horizontal succession and in in-line construction. The individual printing units include two platforms, in particular receiving elements, such as bearing blocks or bearing brackets and drive shafts, that releasably receive printing unit subassemblies or printing unit components/printing unit modules so that functioning printing units are created. The printing units can, in particular, be converted between the following printing processes: flexographic printing, gravure, lithographic offset printing, screen printing. The platforms are movable relative to each other and relative to an impression cylinder along a linear path to bring the respective component/subassembly/module into engagement with the web of printing material guided by the impression cylinder.

In order to increase the options of intervention for printing multiple individual color separations in an in-register way, it may be useful to equip such a generic convertible printing press with a device for the adjustment of the diagonal register. German Patent DE 563 833, for example, discloses compensating for transfer differences of multiple gravure plate cylinders disposed about an impression cylinder by constructing the axes of the gravure plate cylinders so as to be adjustable to be tilted relative to the impression cylinder. In concrete terms, in particular, the support device for supporting the gravure plate cylinder may be adjustable, in that pivot brackets are received in such a way that they are eccentrically supported in trunnions. Adjustable bearings or journals may be provided instead of the trunnions, or the bearings of the gravure plate cylinders may be adjustable.

A pivoting movement of a bearing location may, however, change the engagement or contacting pressure between the plate cylinder and the web of printing material on the impression cylinder, which may require further secondary correcting measures.

### SUMMARY OF THE INVENTION

It is accordingly an object of the invention to provide a printing press, which overcomes the hereinafore-mentioned disadvantages of the heretofore-known devices of this general type and which has a diagonal register adjustment and a printing unit which is convertible between different printing processes and permits the diagonal register adjustment to be uncoupled from engagement between the printing unit and a web of printing material.

With the foregoing and other objects in view there is provided, in accordance with the invention, a printing press for processing a web of printing material, in particular for producing labels or packaging. The printing press comprises a plurality of printing units convertible between different printing processes. Each of the printing units has a cylinder with an axis of rotation and an impression cylinder with an axis of rotation. The cylinder and the impression cylinder form a nip therebetween and define an engagement direction therebetween. Each of the printing units has at least one receiving element for releasably connecting and receiving a printing unit subassembly or a printing unit component for implementing the printing process (defined by the printing unit subassemblies or printing unit components) on the web of printing material passing through the printing unit in the nip. The at least one receiving element executes a linear movement perpendicular to the engagement direction for tilting (i.e. pivoting, crossing, swiveling) the axis of rotation of the cylinder relative to the axis of rotation of the impression cylinder.

To put it differently, due to the linear movement of the receiving element, the axes of rotation of the cylinder and the impression cylinder can be moved from a parallel position into a position in which the axes of rotation are skewed at an unchanged minimum perpendicular distance from each other. In other words, the axis of rotation of the cylinder is pivoted out of the plane defined by the parallel axes of rotation about an axis that is parallel to the plane.

The printing unit subassembly or printing unit component can be received in the receiving element through the use of a bearing. A conversion of a printing unit may be carried out, in particular, without damage to the printing unit in an easy manner through the use of releasable connections of individual parts of the printing unit. The at least one receiving element is preferably disposed on the operator side. The printing unit subassemblies or printing unit components to be received for the conversion may be received on a receiving platform of the printing unit. The receiving element may be part of a receiving platform, in particular a bearing location or a bearing block, or may be an entire receiving platform. The printing unit subassembly may be a cylinder. The printing unit component may be a cartridge containing a plurality of individual printing unit subassemblies. The printing unit may be referred to as a hybrid printing press. The printing material may, in particular, be paper, cardboard, foil, or a material for self-adhesive labels. The printing press may be a narrow-web printing press. The width of the web of printing material may be less than 900 mm, in particular less than 500 mm. The printing press is, in particular, suitable for multicolor printing. A convertible printing unit is, in particular, a printing unit for printing an individual color separation onto one side of the web of printing material. In other words, a printing unit, in particular, includes only a single plate cylinder.

The invention advantageously provides diagonal register adjustment without a resultant change in the contact pressure conditions. Errors that occurred in the prepress stage or during the production of the printing plate, or are due to manufacturing tolerances, can be compensated for mechanically without influencing the engagement between the printing unit and the web of printing material. The amount of waste prints can be reduced. It may even be possible to eliminate waste. A further advantage is that the diagonal register is defined by the receiving element, which remains in the printing press when the printing process is changed and can thus be used independently of the printing process and to the same effect for each printing unit subassembly or printing unit component to be received. In this manner, a very operator-friendly diagonal register adjustment is provided, since only one adjustment needs to be made.

In accordance with another feature of the invention, the printing unit subassembly or the printing unit component is removable from the rest of the printing press and the printing unit is convertible without removing the impression cylinder from the printing unit and/or without modifying the path of the web of printing material through the printing press and/or without severing the web of printing material. In other words, different printing processes use the same impression cylinder or the same printing press configuration. In refined embodiments of the printing press, the impression cylinder, too, may be convertible or removable independently of the printing unit subassembly or printing unit component.

In accordance with a further particularly preferred feature of the invention, the linear movement in the printing press is caused by an adjustment device component which converts a linear movement in a direction different from the direction of the movement of the at least one receiving element or a rotary movement into the linear movement of the at least one receiving element. The adjustment device component may, in particular, be a wedge cooperating on an inclined plane with a sliding surface of a printing unit component, in particular a slide block, so that when the wedge moves in the direction of the ascending slope of the inclined plane, the slide surface of a printing unit component, in particular the slide block, is movable perpendicular to the movement of the wedge.

In accordance with an added feature of the invention, in embodiments of the printing press, the engagement of the cylinder with the impression cylinder in the horizontal direction and the tilting of the axis of rotation of the cylinder relative to the axis of rotation of the impression cylinder may be implemented by a movement of the receiving element in the vertical direction.

In accordance with an additional feature of the invention, in addition or as an alternative, the convertible printing unit may be a lithographic offset printing unit, with the cylinder being a plate cylinder or a blanket cylinder, or the convertible printing unit may be a flexographic printing unit or a gravure printing unit, with the cylinder being a plate cylinder. The printing press may furthermore include one or more printing units that use the following printing processes: screen printing, letterpress printing, xerographic printing, inkjet printing. Moreover, the printing press may include one or more cutting units, stamping units, in particular hot-foil stamping units, or diecutting units.

In the case of lithographic offset printing (indirect planographic printing), a person skilled in the art will immediately realize that when the blanket cylinder is tilted relative to the impression cylinder, a corresponding movement of the plate cylinder relative to the impression cylinder is necessary to prevent compensation of the tilting by a counteracting tilting between the blanket cylinder and the plate cylinder. If the plate cylinder and blanket cylinder are disposed in one printing unit component, for example in a cartridge, insert, or attachment, the tilting may be achieved by tilting the entire printing unit component.

In accordance with yet another feature of the invention, the at least one receiving element may be displaceable relative to a base frame of the printing unit in a direction perpendicular to the lateral direction and/or the printing unit may include at least two receiving elements which are adjustable relative to each other and relative to the base frame of the printing unit.

In accordance with yet a further feature of the invention, the printing unit includes a display element for displaying a degree of tilting of the axis of rotation of the cylinder relative to the axis of rotation of the impression cylinder.

In accordance with yet an added feature of the invention, at least one other receiving element which is different from the receiving element which is movable linearly may at the same time form a driving interface for the printing unit subassembly and/or printing unit component.

In accordance with a concomitant feature of the invention, the printing units of the printing press may be disposed substantially in the horizontal direction and in in-line construction, and/or the printing units may be driven separately by individual drives, and/or the printing length (format length) and/or the printing width of the printing units may be variable. Typical format lengths are between 30.48 and 60.96 centimeters (12 and 24 inches).

Other features which are considered as characteristic for the invention are set forth in the appended claims.

Although the invention is illustrated and described herein as embodied in a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF SEVERAL VIEWS OF THE DRAWINGS

FIG. 1 is a fragmentary, diagrammatic, perspective view of a convertible printing unit in accordance with one embodiment of a printing press according to the invention;

FIG. 2 is an enlarged, fragmentary, perspective view of the printing unit shown in FIG. 1, illustrating a diagonal register adjustment in accordance with the invention as well as a display element;

FIG. 3 is a view similar to FIG. 2 of the diagonal register adjustment without a bearing plate; and

FIGS. 4A, 4B and 4C are diagrammatic representations of different embodiments, wherein an adjustment is implemented through the use of a wedge to convert a linear movement in a first direction into a linear movement into a second direction.

### DETAILED DESCRIPTION OF THE INVENTION

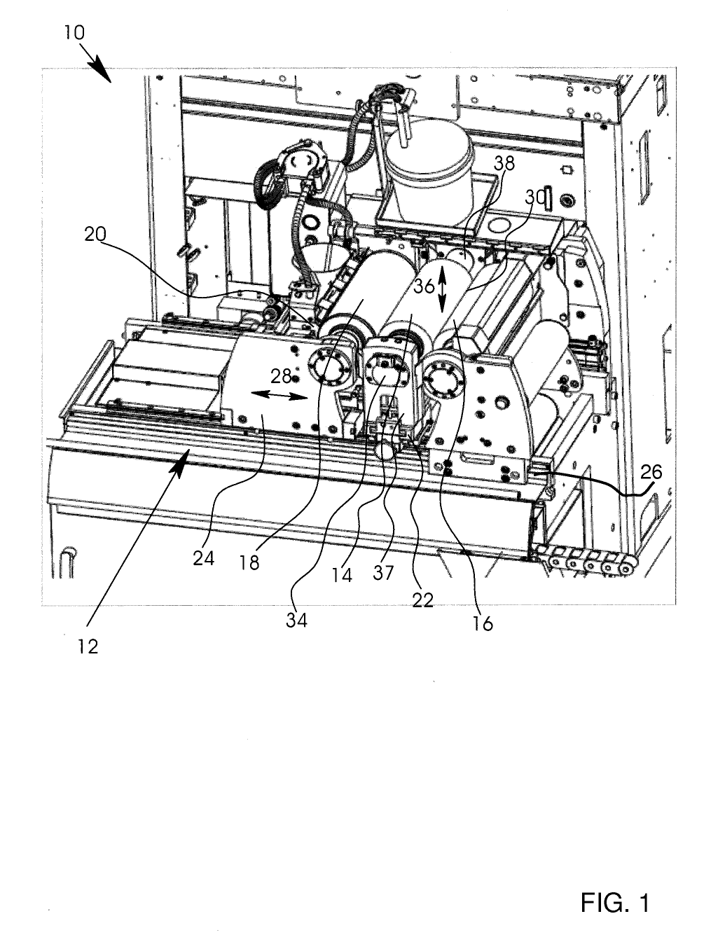

Referring now to the figures of the drawings in detail and first, particularly, to FIG. 1 thereof, there is seen a convertible printing unit 12 of one embodiment of a printing press 10 according to the invention. The press is a Gallus RCS printing press for multicolor printing. The operator side is shown in the foreground and the drive side is in the background. The printing press 10 includes a plurality of such printing units in in-line construction and is constructed for label printing, in particular for printing self-adhesive labels. This embodiment of the printing press according to the invention is also known as a narrow-web label printing press. The printing press 10 furthermore includes an unwinding device for unwinding an unprocessed web of printing material. A web of printing material includes a carrier layer and a substrate layer. Diecutting units are provided downstream of the printing units 12 to cut the labels that have been printed onto the substrate layer out of the web of printing material without severing the carrier web. Moreover, a wind-up device is provided for winding-up the processed web of printing material, i.e. the carrier web with the labels located thereon.

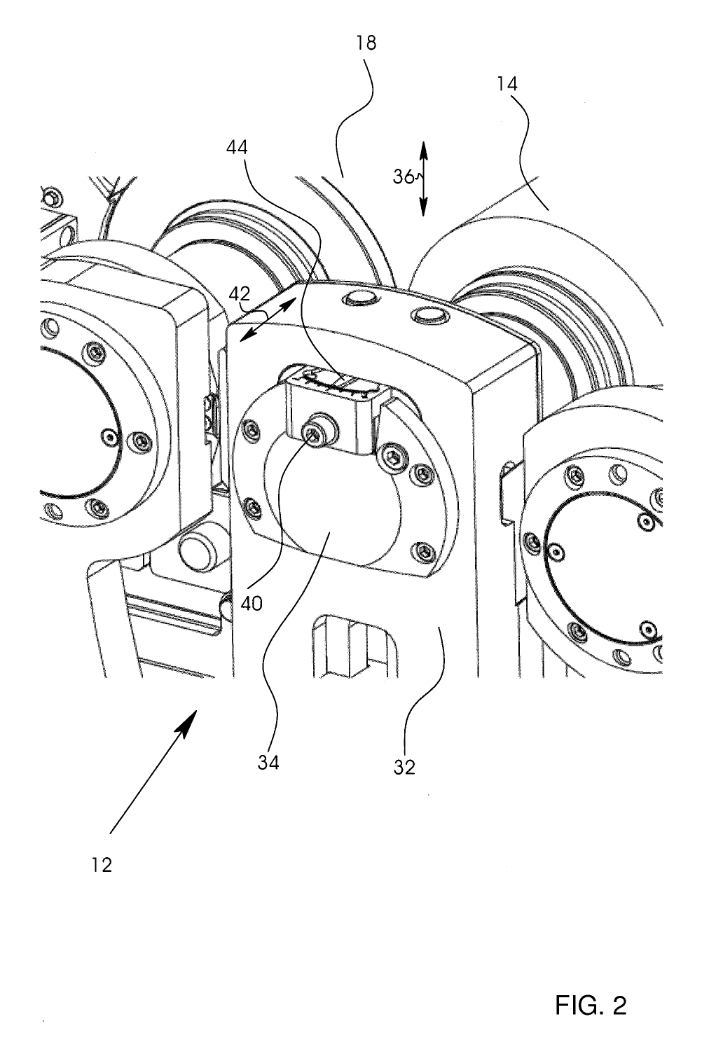

This convertible printing unit 12 is configured as an example of a flexographic printing unit. A removable cylinder 14 is a plate cylinder which, during operation, forms a printing nip 30 with an impression cylinder 16 which guides the web of printing material. The convertible printing unit 12 further includes a screen roller 18, to which printing ink is applied through the use of a blade-type ink chamber 20. The cylinder 14, in this case the plate cylinder, is received on a first platform 22. The screen roller 18 and the blade-type ink chamber 20 are received on a second platform 24. Both platforms 22, 24 are linearly movable along guide supports 26 or guide rails, relative to the impression cylinder 16 and relative to each other, so that the individual printing unit components can be brought into engagement in a direction of engagement 28 with the web of printing material guided by the impression cylinder 16. Different printing lengths (printing formats) can be implemented by using cylinders of different sizes. A distance between axes of rotation is variable in the direction of engagement 28. The printing units 12 of the printing press 10 are driven individually (direct drive). Two servomotors, which are not visible in this representation, are located on the drive side of the printing unit 12. One servomotor is associated with each respective platform 22, 24. On one hand, interfaces with the servomotors allow a mechanical fixing (receiving elements by a friction-locking connection, a force-locking connection, or the like). On the other hand, they also provide a driving connection (through the use of a shaft journal in the example given). The first platform 22 includes such a drive-side receiving element 38. An operator-side bearing plate 32 (see FIG. 2) can be pivoted away to provide access to the printing unit subassemblies or printing unit components received on the first platform 22. The same applies to the second platform 24. In particular, printing unit subassemblies or printing unit components received on the platforms 22, 24 at the interfaces can be separated from their drives. If the printing unit is an offset printing unit, a printing plate cylinder/blanket cylinder component may be received on the first platform 22 (format cartridge), whereas an inking/dampening unit may be received on the second platform 24. If the printing unit is a gravure printing unit, a plate cylinder is received on the first platform 22, and a chambered doctor blade is received on the second platform 24.

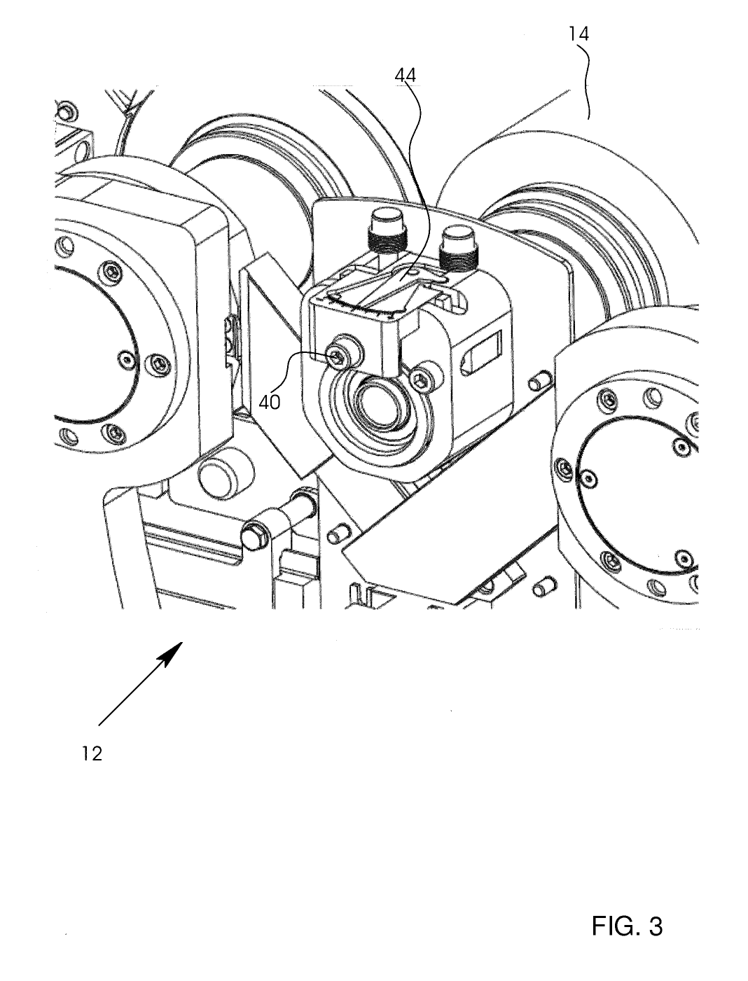

As is seen in FIG. 2, a receiving element 34, which is located in the operator-side bearing plate 32 of the first platform 22, releasably or removably receives the cylinder 14, in this case the plate cylinder for the convertible flexographic printing unit. The receiving element 34 is movable in a direction perpendicular to the engagement direction 28 in the direction of a tilting movement 36, through the use of an adjustment device that will be explained in more detail below with reference to FIGS. 2 and 3. Thus, the axis of rotation of the cylinder 14 can be tilted relative to the axis of rotation of the impression cylinder 16. Such a diagonal register adjustment is made to avoid errors due to an angled position in multicolor printing, resulting from an angled position of the cylinder 14, that is an angled position of the plate cylinder in the given example of a flexographic printing unit, but in general of printing unit subassemblies or printing unit components that are received on the platform 22. By tilting the cylinder 14, that is the plate cylinder in the given example of a flexographic printing unit, but generally speaking the printing unit subassemblies or printing unit components, received on the first platform 22, relative to the impression cylinder, the printed image is positioned at an angle relative to the web of printing material.

As an alternative to the movable receiving element 34 integrated into the operator-side bearing plate 32 as shown in FIGS. 1, 2 and 3, the entire first platform 22, together with the printing unit subassemblies or printing unit components received thereon, may be constructed to be linearly movable for tilting purposes.

FIG. 2 is an enlarged view of a section of the printing unit shown in of FIG. 1, illustrating the diagonal register adjustment of the invention, in particular the linearly movable receiving element 34 and a display element 44 in the bearing plate 22 for the cylinder 14. The receiving element 34 includes an adjustment device having an adjustment screw 40 that is accessible from outside and is operated by a socket wrench. As an alternative to the illustrated adjustment option, the adjustment screw may be operated without tools or an adjustment wheel may be provided. A component of the adjustment device is moved in an adjustment direction 42, in the lateral direction (transversal direction) of the printing press 10, by rotating the adjustment screw 40. This movement in the adjustment direction 42 is converted into the tilting movement 36 in the vertical direction. A quantitative position of the receiving element 34 and thus of the cylinder 14, that is an adjustment value, is made visible to the operator on the display element 44. In the illustrated example, the display element 44 is an analog pointer pointing on a scale. The tilting movement may be an upward movement or a downward movement out of a horizontal plane, which means that the tilting movement has a positive or negative sign. The elements are locked in position by hand using a locking lever or a knurled head screw. The elements are secured in a friction-locking manner through the use of a pretensioned disk spring. In alternative embodiments, the elements may only be secured in a form-locking manner.

FIG. 3 illustrates a view of the diagonal register adjustment with the bearing plate 32 removed for reasons of clarity. In this embodiment of the adjustment device, rotation of the adjustment screw 40 causes a flat wedge with an angle of slope of 3° to be moved in a horizontal, transversal direction. Since the wedge is in contact with a slide surface of a slide block on the operator-side bearing plate 32 of the first platform 22, this horizontal, transversal movement of the wedge is converted into a vertical movement of this slide surface. This causes the cylinder 14, that is the plate cylinder in the illustrated example of a flexographic printing unit, but in more general terms the printing unit subassemblies or printing unit components, received on the first platform 22, to be adjusted in the vertical direction in the bearing location relative to the impression cylinder 16 or rather the printing material. In this embodiment, the adjustment resolution is approximately 0.01 mm. The maximum adjustment path is +/−0.15 mm with reference to the printing width. The adjustment may advantageously be implemented in the loaded state through the use of a tool. At the bearing location, only small hystereses are effective. Consequently, the adjustment also works under pressure. Due to the direct action on the bearing location, no additional tolerances are introduced.

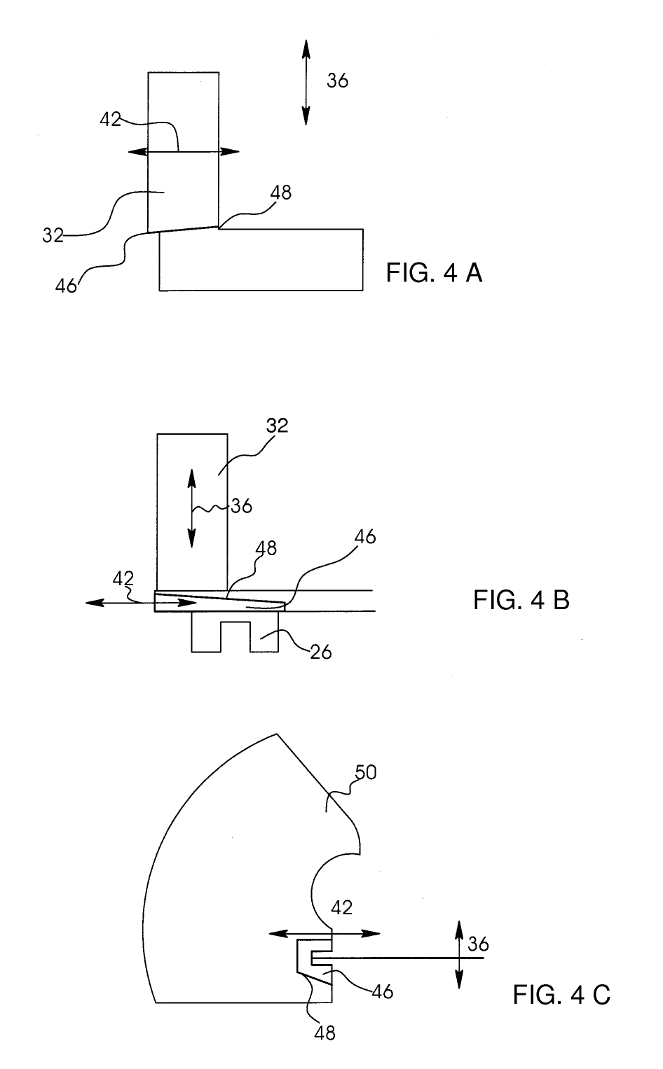

FIGS. 4A, 4B and 4C diagrammatically illustrate different embodiments as alternatives to the one shown in FIGS. 1, 2 and 3. In the embodiments of FIGS. 4A, 4B and 4C, an adjustment is carried out through the use of a wedge for converting a linear movement in a first direction into a linear movement in a second direction. In the embodiment shown in FIG. 4A, the adjustment device has a wedge 46 cooperating with a slide surface 48 provided on the operator-side bearing plate 32, so that an adjustment of the bearing plate 32 in the horizontal, lateral direction results in a tilting movement 36 in the vertical direction. In the embodiment illustrated in FIG. 4B, a wedge 46 cooperating with a slide surface 48 is located between the guide support 26 and the operator-side bearing plate 32 to cause a tilting movement 36 in the vertical direction through the use of an adjustment of the bearing plate 32 in the horizontal, lateral direction. Finally, FIG. 4C illustrates how a wedge 46 with a slide surface 48 of an inking unit 50 for lithographic offset printing cooperates with the convertible printing unit 12, so that an adjustment of the bearing plate 32 in the horizontal direction, perpendicular to the lateral direction, results in a tilting movement 36 in the lateral direction.

1. A printing press for processing a web of printing material, the printing press comprising:
a plurality of printing units convertible between different printing processes;
each of said printing units having a cylinder with an axis of rotation and an impression cylinder with an axis of rotation, said cylinder and said impression cylinder forming a nip therebetween and defining an engagement direction therebetween;
each of said printing units having at least one receiving element for releasably connecting and receiving a printing unit subassembly or a printing unit component for implementing the printing process on the web of printing material passing through said printing unit in said nip; and
said at least one receiving element executing a linear movement perpendicular to said engagement direction for tilting said axis of rotation of said cylinder relative to said axis of rotation of said impression cylinder.

2. The printing press according to claim 1, wherein said printing unit subassembly or said printing unit component is convertible from a remainder of the printing press without removing said impression cylinder from the printing press and/or without modifying a path of the web of printing material through the printing press and/or without severing the web of printing material.

3. The printing press according to claim 1, which further comprises an adjustment device having a component causing said linear movement to be converted into a direction different from a direction of movement of said at least one receiving element or a rotary movement into said linear movement of said at least one receiving element.

4. The printing press according to claim 3, wherein said component of said adjustment device is a wedge cooperating on an inclined plane with a slide surface, for moving said slide surface perpendicular to a movement of said wedge, upon a movement of said wedge in a direction of an ascending slope of said inclined plane.

5. The printing press according to claim 1, wherein an engagement of said cylinder with said impression cylinder in a horizontal direction and said tilting of said axis of rotation of said cylinder relative to said axis of rotation of said impression cylinder are implemented by a vertical movement of said receiving element.

6. The printing press according to claim 1, wherein said convertible printing unit is a lithographic offset printing unit and said cylinder is a plate cylinder or a blanket cylinder.

7. The printing press according to claim 1, wherein said convertible printing unit is a flexographic printing unit or a gravure printing unit and said cylinder is a plate cylinder.

8. The printing press according to claim 1, which further comprises a base frame of the printing press, said at least one receiving element being displaceable relative to said base frame of the printing press in a direction perpendicular to a lateral direction.

9. The printing press according to claim 1, which further comprises a base frame of the printing press, said at least one receiving element of said printing unit being at least two receiving elements adjustable relative to each other and relative to said base frame of the printing unit.

10. The printing press according to claim 9, wherein said at least two receiving elements are displaceable relative to said base frame of the printing press in a direction perpendicular to a lateral direction.

11. The printing press according to claim 1, wherein said printing unit includes a display element for displaying a value of tilting of said axis of rotation of said cylinder relative to said axis of rotation of said impression cylinder.

12. The printing press according to claim 1, which further comprises at least one other receiving element different from said at least one receiving element, said at least one other receiving element being linearly movable simultaneously to form a driving interface for said printing unit subassembly or said printing unit component.

13. The printing press according to claim 1, wherein said printing units are substantially disposed in horizontal direction in in-line construction.

14. The printing press according to claim 1, wherein said printing units are separately driven by individual drives.

15. The printing press according to claim 1, wherein said printing units have at least one of a variable printing length or a variable printing width.

16. The printing press according to claim 1, wherein said printing units produce labels or packaging.
